(19) United States
(12) Patent Application Publication
(10) Pub. No.: US 2003/0093306 A1
(43) Pub. Date: May 15, 2003

(54) Selling system of performance ticket

(76) Inventor: Jiro Onoyama, Tokyo (JP)

Correspondence Address: SHAW PITTMAN LLP, 1650 TYSONS BOULEVARD, MCLEAN, VA, 22102, US

(21) Appl. No.: 10/073,949

(22) Filed: Feb. 14, 2002

(30) Foreign Application Priority Data
Nov. 12, 2001 (JP) 2001-345697

(51) Int. Cl. G06F 17/60

(52) U.S. Cl. 705/5

(57) ABSTRACT

A selling system of a performance ticket including a server that supplies a performance information to a client terminal through a network comprises the server includes a performance information transmitting function which transmits the performance information stored in the performance information DB; an application procedure transmitting function which transmits a purchase information which is stored in a purchase procedure information DB and shown the purport that a selection method of a “lottery system” and an “auction system” about the application of the performance ticket in a display screen of the client terminal; a success-in-an-election probability transmitting function which transmits the success-in-an-election probability information acquired and based on a success-in-an-election probability rule on the basis of a total number of the application and sold ticket number of sheets to the applicant who participates in an auction hall; and a function transmitting notice of success in an election, drawing a lottery means to the applicant who chose the lottery system, on the other hand, awarding with a successful bid means to the participant who chose the auction system, and transmitting the notice of success in the election to the successful bidder and the successful candidate. Since a customer can choose one of a lottery system and the auction systems of his will, a sponsor's profit can also increase as a result, and it can be decreased a “scalper”-act by third person.

### BACKGROUND OF THE INVENTION

The present invention relates to a selling system of the performance ticket that sells the ticket of performance including entertainment, theater and sport through a network to consumer terminals.

The conventional ticket selling system is either of a first-arrival system or lottery systems and a customer cannot choose the purchase method freely. Moreover, in the ticket sale by the first-arrival system, telephone reservation is generally done subsequently, and network sale continues. However, in both of these sales methods, applicants throng suddenly at the time just selling start or before selling start, and the various social problems is raised from viewpoints such as safety and appearance of a scalper. For example, since it stands in a line from a beforehand day on the previous day in the case of popular concert and sport, we are anxious about the management or completeness to people. Moreover, the group who calls “ticket getter” has also appeared aiming at securing the number of sheets collected making full use of computer software and reselling to a person needed at a high price.

In a place, the ticket charge of a concert is not decided to take into consideration the trend (supply and demand) of a market necessarily by problems such as the artist's image and a posture by the side of a sponsor. In this way, it is different from the goods that take the trend of market into consideration and determine a price.

In another way, even if it is the case where acquisition of a ticket will be expected to be difficult depending on the contents of performance in case the ticket charge of performance is decided as a sponsor side, and it is hard to give an overly large sum price and a customer's social or rational intention is disregarded. Consequently, by demanding far exceeds supply to the predetermined ticket charge, the ticket shops and network auctions which perform the so-called the scalper-act occur frequently, and now the scalper preventive measures pose a big problem for the sponsor side.

### SUMMARY OF HE INVENTION

The first purpose of the present invention is controlling a third person's “scalper”-act and increasing the part profit for a seller, while a buyer can choose the purchase method for which oneself wishes. The second purpose is dealing with impartially the person who chose the “lottery system” and the person who chose the “auction system” in the field of success-in-an-election probability. The third purpose is making it less than the successful bid price of the person who chose the “auction system” from the market price of the conventional dub store. The fourth purpose is to cancel inconvenient based on order pours simultaneously with sale and the unfair feeling by the application of the telephone, trough the network, etc.

The novel features which are believed to be characteristic of the invention, both as to its organization and method of operation, together with further objects and advantages thereof, are described below with reference to the accompanying drawings in which a presently preferred embodiment of the invention is illustrated as an example.

It is to be expressly understood, however, that the drawings are for the purpose of illustration and description only, and are not intended as a definition of the limits of the invention.

### BRIEF DESCRIPTION OF THE DRAWINGS

FIGS. 1 to 13 illustrate explanation views showing a first embodiment respectively. FIG. 14 illustrates an effect of the present invention.

FIG. 1 is an explanation view showing a relation between a client terminal and a server;

FIG. 2 is an explanation view showing an example of a basic concept of the present 10 invention;

FIG. 3 is a block diagram showing a function of a controller of the server;

FIG. 4 is an explanation view showing a relation between a controller of the server and display screen for indicating;

FIG. 5 is a structural view of a performance information DB;

FIG. 6 is an explanation view of individual detailed information;

FIG. 7 is a structural view of a purchase procedure information DB;

FIG. 8 is an explanation view of a success-in-an-election probability display screen;

FIG. 9 is an explanation view of a choice screen;

FIG. 10 is an explanation view of a progress situation of an auction;

FIG. 11 is an explanation view of a notice screen for success in an election;

FIG. 12 is a flow view showing a step supplying from performance information to choice information;

FIG. 13 is a flow view showing a step from selection procedure to successful candidate information; and

FIG. 14 is an explanation view showing an effect of the present invention.

### DETAILED DESCRIPTION OF THE PREFERRED EMBODIMENTS

Preferred embodiments of the present invention are described in more detail below referring to the accompanying drawings.

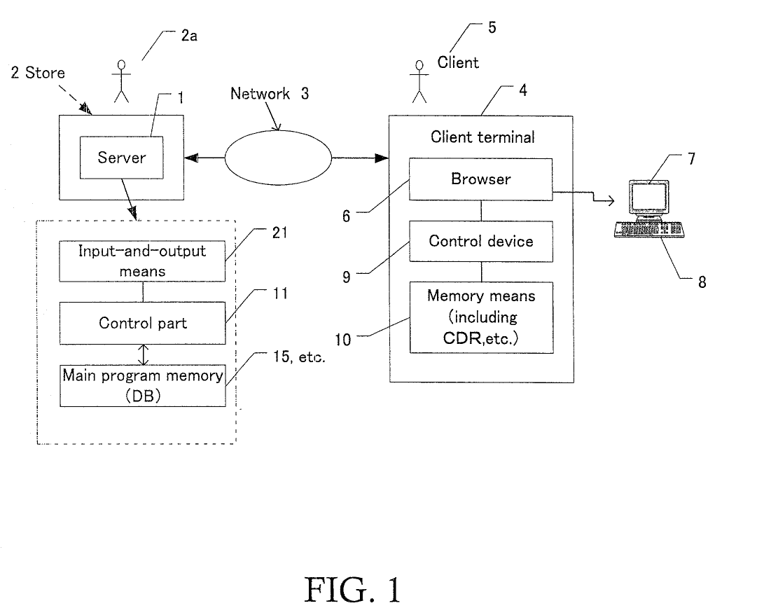

FIG. 1 illustrates the outline diagram showing the selling system of a performance ticket. The fundamental term of this selling system is explained by FIG. 1 as reference. The “Performance” means service such as entertainment, theater, music and sport. Therefore, for example, the ticket of a concert means the admission ticket for going into the concert hall. Here, in order to understand the feature of the present invention, it is not asked whether an admission ticket has seat specification such as S seats and A seats etc. The present invention has a feature that at least two kinds of purchase methods of “lottery system” or “auction system” is chosen when the server applies for the admission ticket to the client terminal through the network and the client terminal has been convinced to the application conditions (contents) of the server.

Now, the numeral 1 shows a server installed into a store 2 that sells tickets. Since the server 1 is equivalent to the Web computer holding the information about the ticket sale, it is equipped with the input-and-output means, a control means to perform the selling system of the present invention based on a main program, a memory means (memory part) to store various databases (DB) and a rule, etc. Moreover, the server 1 is connected to the network 3 through radio or the telephone line. Therefore, since the server 1 connects with the network 3 and it should just hold information to the information memory medium, two or more servers may be prepared. The network 3 is adopted so-called Internet.

On the other hand, the numeral 4 shows a plurality of client terminals connected to the server 1 through the network 3. Since the client terminal 4 is equivalent to the notebook PC occupied by a client 5 as a general consumer domestic, it has a browser 6 which is the software for perusing a homepage. Therefore, the client 5 can receive the performance information on this system into a memory means 10 connected with a control device 9 electrically when the client 5 peruses the homepage of the server 1 on the display screen 7 of the client terminal 4 through the browser 6 and it is purchased (download) by an operation means 8.

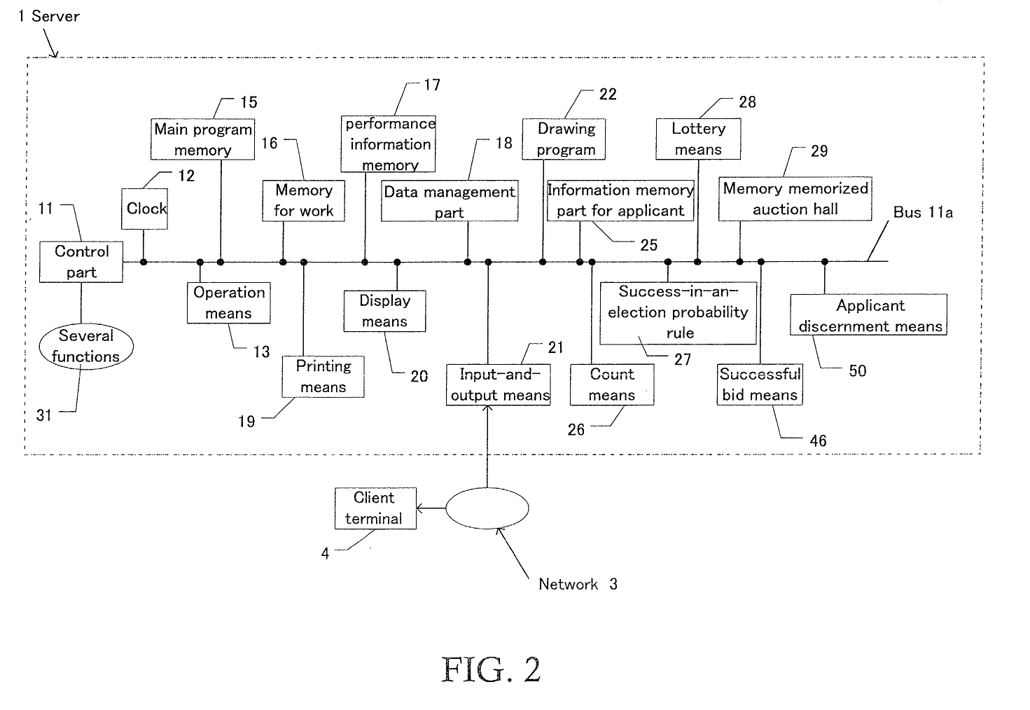

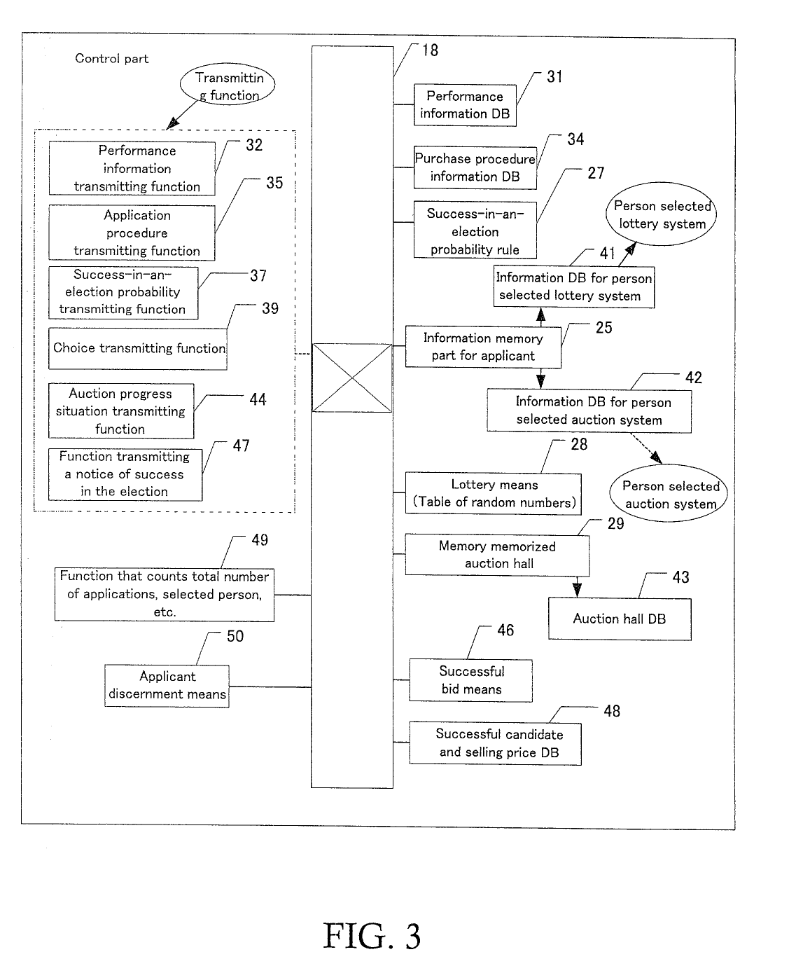

Next, FIG. 2 are the block diagram showing the composition of the server 1. The term that constitutes the server 1 with reference to FIG. 2 is explained. The numeral 11 shows a control part (for example, CPU), and the control part 11 has various kinds of functions as illustrated by FIG. 3. The numeral 12 shows a clock and is used when an administrator 2a of the store 2 inputs the contents (collection time, application period, etc.) of the ticket about performance and selling conditions (an alternative, application qualification, etc.) to the memory part of the server 1 and it goes into the step of an auction mentioned later. The numeral 13 shows an operation means including a keyboard.

The numeral 15 shows a main program memory. Although the terms of a memory part means the memory means of the server 1, it classifies and explains a memory part on the facilities of explanation in this embodiment. In addition, memory means are a hard disk, a flexible disk, an optical disc, etc. A main program memory part 15 consists of memory media including a ROM and a magnetic disk and stores the main program for controlling each function of the server 1.

The numeral 16 shows a memory for work which stores temporarily the data needed in the case of control of the control part 11 after the administrator 2a inputs the title of a concert, a stage name, time, hall, charge, an application registration period, auction information, etc. through the operation means 13.

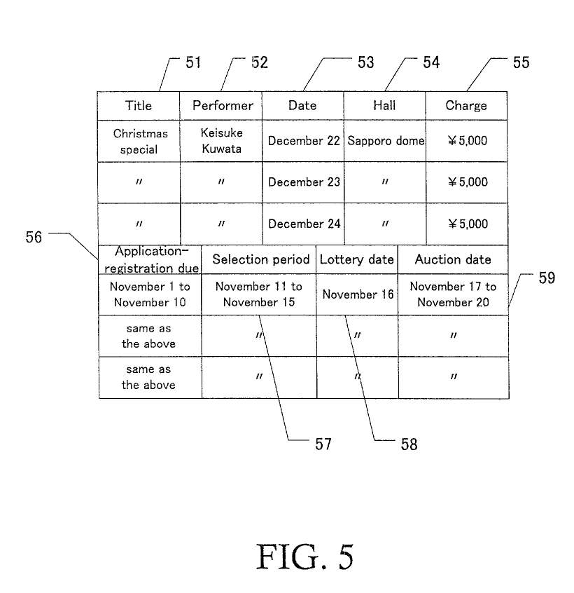

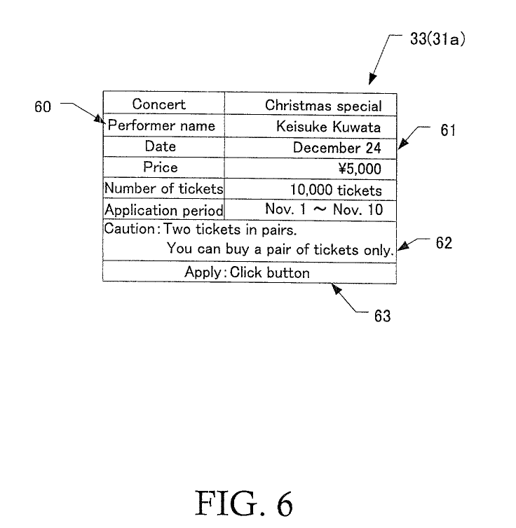

The numeral 17 shows a performance information memory for performance. The contents of the data memorized by the performance information memory 17 are as being shown in FIG. 5 and FIG. 6.

The numeral 18 shows a data processing part. In this embodiment, although the data processing part is one of the functions of the control part 11, since it connects with a bus 11a of the control part 11 and manages a clock, a count means and each updating information on each DB rather than it says that information is stored, the independent strip has illustrated. In addition, the server 1 includes a printing means 19, display means 20, input-and-output means 21, drawing program 22, etc.

Now, the following term relates to the specific requirements for the present invention. The numeral 25 shows an information memory part of an applicant, etc. The information memory 25 memorizes at least applicant name about the performance and its number, the selection person name which chose the lottery system and its total number thereof, and the selection person name which chose the auction system and the total number thereof.

The numeral 26 shows a count means. In the count means 26, it is added to an application total as “a count +1” when an “application button” is clicked (when a will indication which purchases the ticket of the performance is given) after the client 5 who has accessed the server 1 through the client terminal 4 has been convinced to the selling outline of this system while the client 5 looks at the screen of the performance information which the server 1 outputted.

The numeral 27 shows a success-in-an-election probability rule. This success-in-an-election probability rule 27 corresponds to the ratio of the total number of the applications of the performance and the number of sale of the tickets. In this embodiment, although the server 1 urges the client 5 to choose either of “lottery system” or “auction system” after deciding the total number of the applications in the choice screen which can be seen on the display screen 7 of the client terminal 4, the success-in-an-election probability at this time is set up so that it may become the same probability (for example, every 10% and 20% etc. corresponding to the ratio of the total number of the applications) even if it chooses any system.

The numeral 28 shows a lottery means. The lottery means 28 determines a successful candidate impartially for the person who chose the “lottery system” after deciding the total number of applications. The random number table is adopted as the lottery means. By the way, in general, although an admission ticket has seat specification including S seats, A seats, and B seats etc., in such a case, it is natural that a lottery is usually performed one by one corresponding to each seat specification. A lottery day is carried out without delay after the application registration period and selection period progress.

The numeral 29 shows a memory memorized the auction hall etc. The memory part 29 memorizes the hall of an auction, the progress situation of an auction and successful bid information, etc. thereinto. In addition, an applicant discernment means 50 and successful bid means 46 are mentioned later.

Next, FIG. 3 illustrates the composition figure showing the principal part of the server. In another words, FIG. 3 shows the outline diagram that paid its attention to two or more DB(s) stored in the memory part of the server 1 and the function of each control part related with the DB.

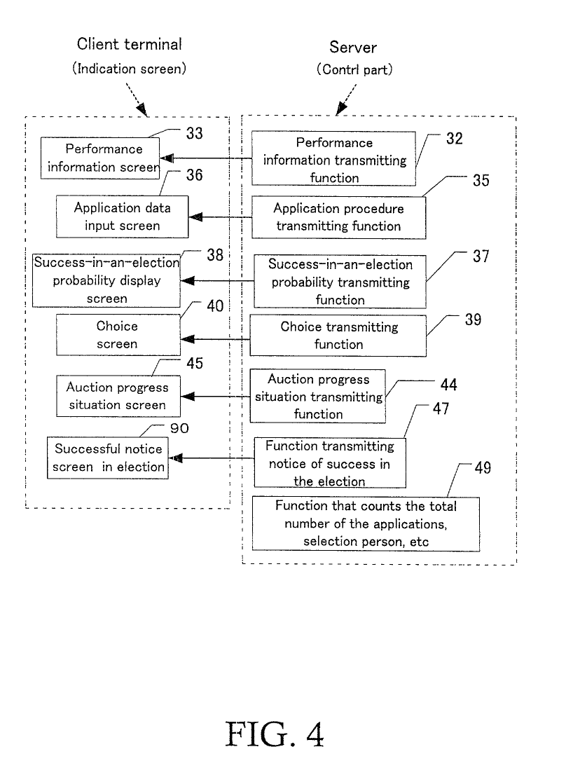

Now, the function of the server 1 is distinguishable to the various functions controlled based on signals of the data processing part 18 and success-in-an-election probability rule and data processing department 18 which manages performance information, an applicant name, total number of the applications, auction information, etc. Then, the relation of each DB and various functions, and the display screen 7 of a client terminal 4 is explained based on FIGS. 3 and 4 as references.

The numeral 31 shows a performance information DB. The performance information DB 31 is stored in the performance information memory 17. A performance information transmitting function 32 outputs the contents of the data memorized into the performance information DB 31 to the client terminal 4. The signal sent from the performance information transmitting function 32 appears as a performance information screen 33 to the display screen 7 of the client terminal 4. So to speak, the contents that appeared on the performance information screen 33 shows the data structures of the performance information DB 31 (FIG. 5). Although not illustrated especially, in addition, since the information of the selection method of the “lottery system” and “auction system” about the application of the performance ticket is also stored into the performance information DB on the server, the performance information transmitting function 32 of this embodiment also transmits the performance the information of the selection method of the “lottery system” and “auction system” about the application of the performance ticket in order to show in the display screen of the client terminal 4.

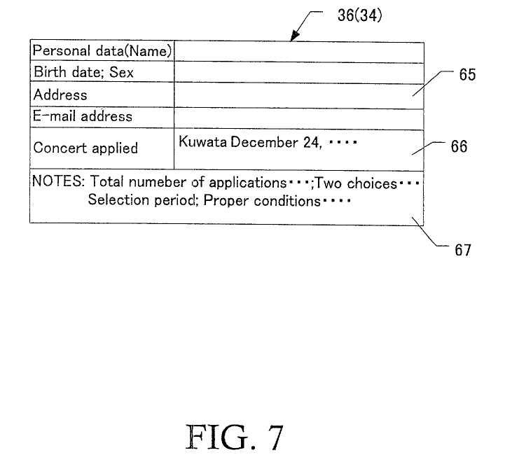

The numeral 34 shows a purchase procedure information DB. The purchase procedure information DB 34 is stored in the information memory parts 25. An application procedure transmitting function 35 of a ticket outputs the contents of the data memorized into the purchase procedure information DB 34 to the client terminal 4. The signal that is sent from the application procedure transmitting function 35 appears as an application data input screen 36 to the display screen 7 of the client terminal 4. So to speak, the contents that appeared on this application data input screen 36 show the data structures of the purchase procedure information DB 34 (FIG. 7).

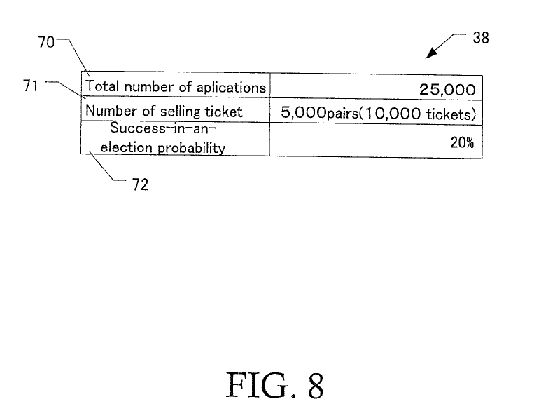

The numeral 27 shows a success-in-an-election probability rule. About the formula of the success-in-an-election probability rule 27, the number of sheets of the ticket put on the market in the performance is distributed in equal corresponding to the ratio of the total number of the applications of the performance to the “lottery system” and “auction system”. A success-in-an-election probability transmitting function 37 outputs the success-in-an-election probability information acquired based on the success-in-an-election probability rule 27 to the client terminal 4 on the stage which the total number of the applications of the performance made clear through the count means 26. The signal sent from the success-in-an-election probability transmitting function 37 appears as a success-in-an-election probability display screen 38 on the display screen 7 of a client terminal 4. The contents of screen 38 displaying the success-in-an-election probability are described as illustrated in FIG. 8.

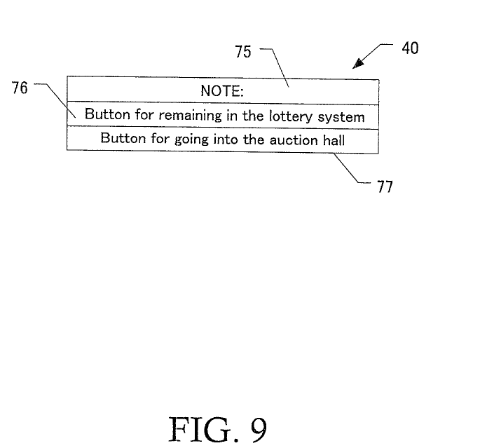

The numeral 39 shows a choice transmitting function. The choice transmitting function 39 outputs the selection information stored in the purchase procedure information DB 34 to the client terminal 4. The signal sent from the choice transmitting function 39 appears as a choice screen 40 to the display screen 7 of the client terminal 4 (FIG. 9).

The numeral 41 shows a person information DB selected the lottery system, and the numeral 42 shows a person information DB selected the auction system. An applicant's data of the applicants who chose the lottery system is stored in a lottery system selection person information DB 41, on the other hand, an applicant's data of the applicants who chose the auction system is stored in an auction system selection person information DB 42. The lottery system selection person information DB 41 and the auction system selection person information DB 42 are memorized in the information memory parts 25 with the data of the total number of the applications.

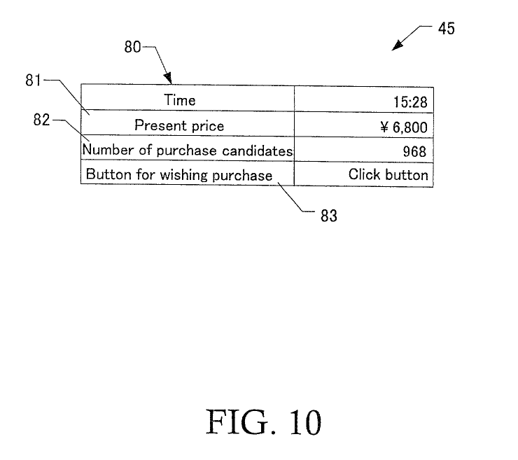

The numeral 43 shows an auction hall DB stored in the memory 29. The contents of the data in the auction hall DB 43 are sent to the client terminal 4 by an auction progress situation transmitting function 44. An auction progress situation screen 45 which shown in the display screen 7 of the client terminal 4 is as shown in FIG. 10.

The numeral 46 shows a successful bid means. The successful bid means 46 decides a successful candidate for the applicant who participated in the auction hall. The numeral 47 shows a function transmitting a notice of success in the election that notifies each successful candidate who is decided by the successful bid means 46 and the lottery means 28 to the client terminal 4. The numeral 48 shows a successful candidate and the selling price DB that stores the selling price of the ticket and the successful candidate name. The numeral 49 shows a function that counts the total number of the applications, selection person, lapsed time, the number of settlement of accounts, etc. based on the count means 26. The numeral 50 shows an applicant discernment means 50, and in this embodiment, the applicant discernment means 50 achieves the check function to prevent from a fair viewpoint when the applicant registered into the lottery system selection person information DB 41 participates also in the auction hall further. Of course, since the person defeated in the lottery system depending on the case of the operation may make it the system that can participate in the auction hall, in such case, the applicant discernment means 50 is not in dispensable requirements.

Next, the data structure is explained. The server 1 of the present invention urges to choose either “lottery system” or “auction system” to the accessed client terminal 4 about sale of the ticket in the Internet 3. Therefore, the column relevant to the selection is prepared also in the data structure of the performance information DB.

FIG. 5 is a diagram showing typically the contents of data of the performance information DB 31. Hereafter, the concert of Southern all stars which famous in the performance of a song and music is mentioned as an example and explains.

The numeral 51 shows a title area (for example, Christmas special) of performance; 52 shows a performer name area (for example, Keisuke Kuwata); 53 shows a date area (for example, December 22, December 23, December 24); 54 shows a hall area (for example, Sapporo dome); 55 shows a ticket charge area (for example, 5,000 yen); 56 shows an application-registration period area for all candidates (for example, November 1 to November 10); 57 shows a selection period area which the person who knew the success-in-an-election probability 57 and who applied within the application period choose the “lottery system” or “auction system” (for example, November 11 to November 15); 58 shows a lottery day area of the lottery system (for example, November 16); and 59 shows an auction date area which actually carries out an auction (for example, November 17 to November 20).

When the client terminal 4 can access the homepage of the server 1, for example, the 5 contents of data of the performance information DB 31 can be seen through guidance screens including a performer name list and a title list. Then, although not illustrated especially, the feature matter of the present invention can also be seen on an abstract screen. When the client 5 looks at the performance information screen 33 of “Keisuke Kuwata” on the display screen 7 of the client terminal 4, the title of the title area 51 is the same state; the matter that a concert will be held several days is shown by the “line.”

FIG. 6 shows an example of composition of the individual detailed information. The individual detailed information 31a is located at the lower layer information on the index performance information DB 31. Therefore, when there is a concert that the client 5 wishes in the performance information screen 33, the individual detailed information 31a can be seen by clicking the specific part of the performance information screen 33. The individual detailed information 31a has the specification item area 60 of performance contents in left side thereof, on the other hand, the performance condition area 61 corresponding to the specific item is located on right side thereof. Moreover, a note area 62 about a group of the tickets and the application introduction area 63 are located in the lower part of these areas.

The cautions are shown about “how many tickets the client can purchase by himself” in the note area 62. Moreover, if the application introduction area 63 is clicked, the application data input screen 36 is appeared as illustrated in FIG. 7.

The content of data described in FIG. 6 appears when the client 5 chooses the concert of “Keisuke Kuwata” on December 24. For example, when “December 24” of the date area 53 described in FIG. 5 is clicked, the details of the Christmas special on December 24 will appear.

FIG. 7 shows an application data input screen 36 and includes a personal information input area 65 urged so as to input a personal information to the client 5, a contract-terms area 66 which showed the contents item of the performance or performance conditions and an auction information area 67.

In the auction information area 67, the conditions are described as follows: “the applicant understand the total number of the applications or success-in-an-election probability after due period progress; the applicant has two choices; the applicant must choose either (a) remain in a lottery system like turning to God for help or (b) must choose the lottery system or auction system; a selection period; a lottery day; an auction enforcement period; and the proper conditions about the auction system.

In addition, the present invention has a feature matter that the client chooses at least two kinds of purchase methods “lottery system” or “auction system” after the server 1 applies for the admission ticket to the client terminal 4 through the network 3, and the client 5 who looked at the display screen 7 of the client terminal 4 has been convinced to the application conditions (contents) of the server. Therefore, as mentioned above, also the feature matter can be shown in the performance information screen 33.

Thus, in the embodiment of the present invention, before the client 5 inputs a matter required into the application data input screen 36 and clicks the “last application button” and completes the application, the feature is that it notifies to the client that “another purchase system is offered beforehand to the client surely needed the ticket of the performance although it becomes higher than the regular price after the success-in-an-election probability (or total number of the applications) of the performance becomes clear”. In addition, the application data input screen 36 corresponds to the contents of the data in the purchase procedure information DB 34 stored in the information memory parts 25, as mentioned above.

FIG. 8 shows an example of a success-in-an-election probability display screen 38 and includes a total application area 70 concerning the performance, the number area 71 of selling tickets, and a success-in-an-election probability area 72. The client 5 can know the degree of popular of the performance with the success-in-an-election probability display screen 38 after the application registration period end. Then, the client (here all applicants) 5 can see the choice screen 40 with the success-in-an-election probability display screen 38 through the display screen 8. Of course, only those who participate in the auction system may be able to see the success-in-an-election probability display screen 38 in each embodiment in the present invention.

FIG. 9 shows an example of a choice screen 40. And includes a note area 75, a button field 76 which remains in the lottery system, and a button field 77 which goes into the auction hall. The note area 75 has the description as follows: “choose either lottery system and auction system; when both is chosen, it becomes invalid; when it becomes clear that they are ticket getter and a scalper later, the ticket acquisition condition loses; the lottery system is done impartially by the lottery means 28; the success-in-an-election probability does not change even if either of system is chosen; and when is the opening time and what day is open the auction”.

FIG. 10 shows a progress situation screen 45 as an example of the auction hall screen. The progress situation screen 45 includes a time area 80 which shows the present time, a present price area 81 which shows the price in this time of the ticket which is able to be distributed, a number area 82 of purchase candidates which shows the sum total of the number of purchase candidates under watching, and a button field 83 wishing purchase for displaying the intention of purchase.

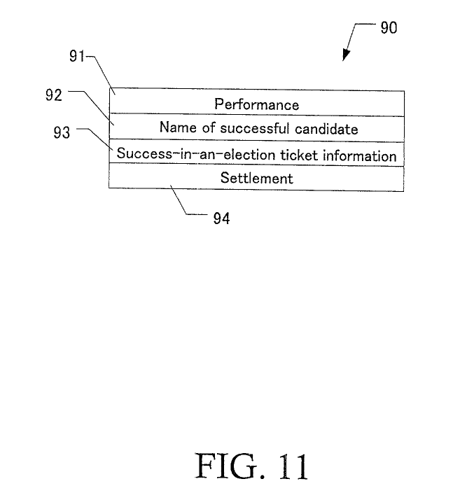

FIG. 11 shows a successful notice screen 90 and includes a performance area 91 showing the contents of performance which subscribed, a name area 92 which shows the name of the successful candidate who won lottery system and auction system respectively, a success-in-an-election ticket information area 93 which shows the classification and price of a ticket, and a settlement area 94 which shows the settlement method.

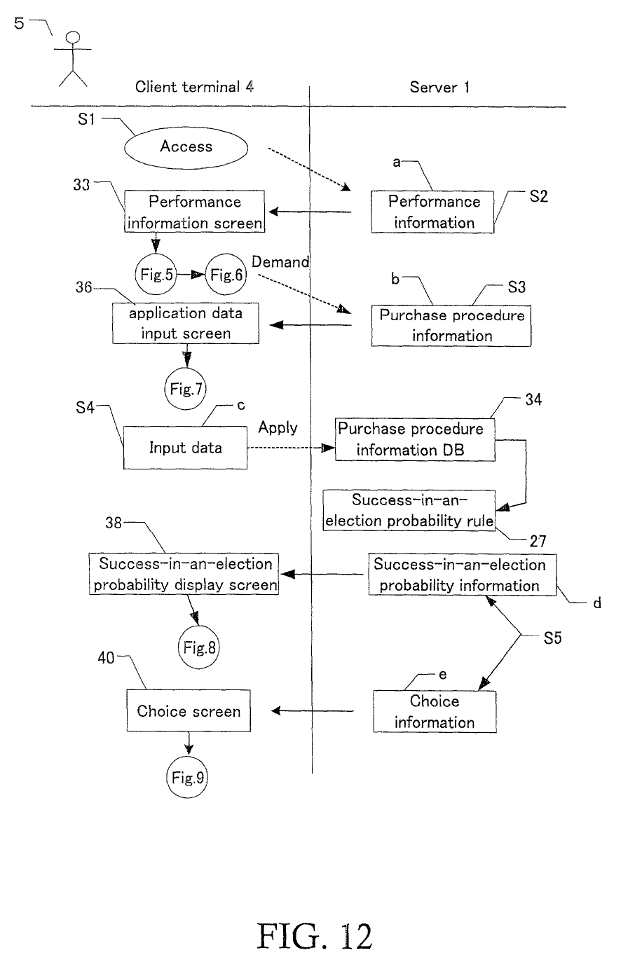

FIG. 12 shows the diagram showing a flow of main processing with the client terminal 4 and server 1. In addition, the exchange of the signal in the server 1 is also included.

In S1 step, the customer accesses the server 1 through the client terminal 4 first. When the client 5 connects with the server 1, he can see the performance information a stored in the performance information DB 31. Then, in S2 step, the server 1 transmits the performance information a to the client terminal 4 through the performance information transmitting function 32 by the demand from the client terminal 4. The client 5 can see the performance information screen 33 as illustrated in FIG. 5. After that, when the client 5 has the performance which he wishes into the performance information screen 33, he can see lower layer individual detailed information by clicking the predetermined part in the performance information screen 33 (FIG. 6).

In S3 step, the server 1 transmits the purchase procedure information b to the client terminal 4 through the application procedure transmitting function 35 by the demand from the client terminal 4. The client 5 can see the application data input screen 36 as illustrated in FIG. 7. Then, the client 5 inputs the personal information urged from the server through the operation means 8 into the personal information input area 65.

In S4 step, when the client 5 understands the matter shown in the auction information area 67 and the input is completed, the client 5 clicks the “last application button” and transmits the input data c to the server 1. After the input data c is received from the client terminal 4, the server 1 is dealt with as “an application” through the count means 26 and carries out updating registration at the purchase procedure information DB 34.

In S5 step, after the application registration period 56 of the performance passes, the server 1 calculates the success-in-an-election probability of the performance based on the success-in-an-election probability rule 27 and transmits the success-in-an-election probability information d to the client terminal 4 through the success-in-an-election probability transmitting function 37. At this time, the server 1 transmits the choice information e to the client terminal 4 simultaneously through the choice transmitting function 39. Therefore, the client 5 can see the success-in-an-election probability display screen 38 as illustrated in FIG. 8 and the choice screen 40 as illustrated in FIG. 9 respectively on the display screen 7 of the client terminal 4.

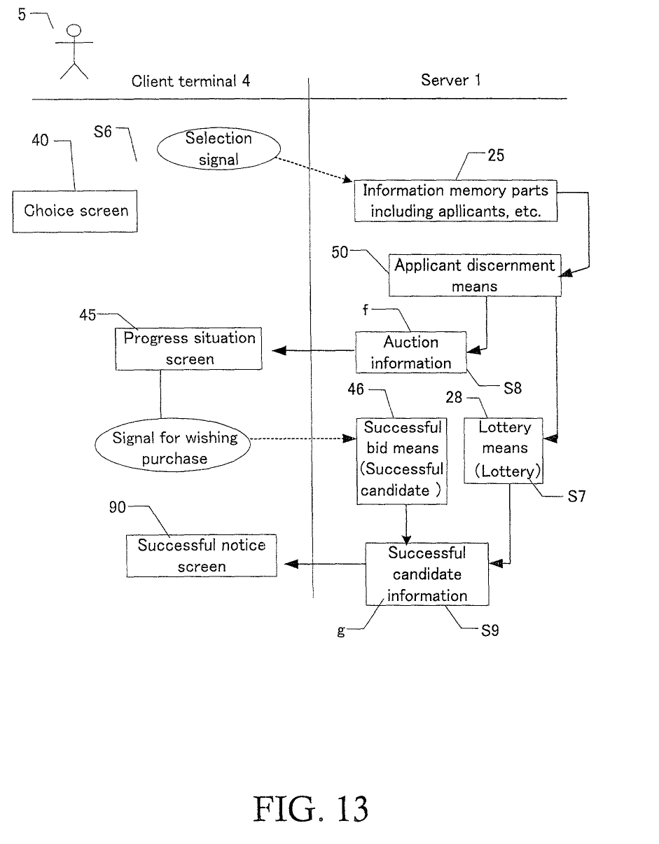

FIG. 13 shows a flow showing a condition after transmitting success-in-an-election probability information. As mentioned above, the client 5 has to choose (a) lottery system or (b) auction system within a selection period after seeing the success-in-an-election probability display screen 38.

In S6 step, the server 1 receives a selection signal from the client terminal 4 and registers it into the information memory parts 25 corresponding to the kind selection signal. In this case, as illustrated in FIG. 3, the lottery person data that is chosen the lottery system is stored in the lottery system selection person information DB 41; on the other hand, the auction person data that is chosen the auction system is stored in the auction system selection person information DB 42, respectively. In this embodiment, the client 5 who subscribed within the application registration period shown in FIG. 5 is altogether registered into the information memory parts 25. And those who can participate in the auction hall later are limited to the person who participated in the information memory parts 25, in principle.

By the way, in this embodiment, since the applicant registered into the lottery system selection person information DB 41 may participate also in the auction hall, he is checked with the applicant discernment means 50. Therefore, even if the person defeated in the lottery system or elected by the lottery system wish to participate in the auction, it is excepted with the applicant discernment means 50.

In S7 step, the lot is carried out through the lottery means 28 on a lottery day for the applicant registered into the lottery system selection person information DB 41.

On the other hand, S8 step transmits the auction information f to the client terminal 4 through the progress situation transmitting function 44 on the auction date (a time zone which is carrying out the auction) 57 for the participants registered into the auction system selection person information DB 42. The client 5 can see the progress situation screen 45 as illustrated in FIG. 10 on the display screen 7 of the client terminal 4. The content of the progress situation screen 45 changes every moment with the signal for wishing purchase from the client terminal 4. Thus, although the price of the ticket rises when the participants in the auction increase in number, it is soon awarded by many clients within the limits of success-in-an-election probability in the stage which the high price stopped.

In S9 step, a successful bidder and successful candidate are made into “the successful candidate information g”, and it transmits to the client terminal 4 through the notice of success in an election transmitting function 47. At this time, the server 1 registers the successful candidate information g into the successful candidate and the selling price DB 48. The client 5 can see the successful notice screen 90, as illustrated in FIG. 10, on the display screen 7 of the client terminal.

In this embodiment, the server 1 urges the client 5 to choose either the “lottery system” or “auction system” after deciding total number of applications. In another way, the applicant (candidate) of a ticket chooses either “lottery system” or “auction system” after he knew the success-in-an-election probability of the performance after the application registration period end and thinking within a selection period.

However, since the purpose of the present invention is selling the ticket to the candidate of the ticket impartially while controlling a “scalper”-act, it can urge the client 5 to choose either “lottery system” or “auction system” within the application registration period (for example, at the time of the application). In this embodiment, the person who chose the auction system cannot know the success-in-an-election probability beforehand. However, since the selling person 2a knows the degree of popular of the performance, the performance place, the price, etc. as the law learned by experience, it prepares “success-in-an-election probability anticipation “DB” in the memory part of the server 1 further, and it may be transmitted the anticipation information in the success-in-an-election probability anticipation DB to the client terminal 4 through the transmitting function of the success-in-an-election probability anticipation information.

Moreover, the candidate of a ticket is notified of the method for selecting either of “lottery system” or “auction system” within the application registration period (for example, at the time of the application) on the display screen etc., and lots are behind cast automatically through the lottery means to the person who applied for the ticket within an application registration period. On the other hand, at the stage that the application total decided, and after notifying of the success-in-an-election probability to those who wish the auction system, the auction may be carried out.

Therefore, the feature of the present invention includes two kinds of system, that is “lottery system” and “auction system” at the time of the purchase of a ticket, does not matter of decision order of the total number of the applications and is transmitting the information based on the rule of a fair principle to the client terminal.

The following explains concretely an example for letting you understand the feature of the present invention. As mentioned above, the sale of the ticket is subscribed by the Internet and a random lottery system is performed. A sponsor (selling person) decides the amount of money and the selling number of sheets of a ticket. 10,000 sheets are put on the market temporarily in all seats of 5,000 yen. As a result of collecting a purchase candidate, suppose that there are 50000 applications. At this time, the sponsor informs all applicants of the total number of the applications. That is, telling all applicants that the success-in-an-election probability of the performance is 20% the two choices are transmitted to the applicant as follows:

(1) Wait and pray that believe 20% of possibility and a ticket is sent.

(2) Go into the next stage or auction hall.

As mentioned above, the selections (1) and (2) are selected with an applicant's free intention to the last. This is to correspond to the applicant's needs of “we want to get the ticket with payment of extra charge”, it is not from the idea that the sponsor is profit more.

When there are 45,000 persons (90%) who remained in (1) and 5,000 persons (10%) who did declaration of intention of going to the stage of (2), 10,000 tickets are divided in 9,000 sheets for a lottery and 1,000 sheets for auctions according to the ratio.

Therefore, the success-in-an-election probability of the customer who chose the lottery system does not change or remarkably at all. Moreover, the auction participant can go into a stage and the auction hall by the same probability as the lottery person.

The auction is knocked down in the place that raised the price in the usual way until 1,000 higher ranks remained. When the sponsor is anxious about a price going up too much and becoming “an extraordinary price”, the maximum value of the auction is set up beforehand and the customer is told about performing the maximum lottery by the people that remained to the maximum value. Since the success-in-an-election probability is still higher than a simple lottery, the participant must be conviction.

As set forth above, the customer can choose one of a lottery system and the auction systems of his will so that a sponsor's profit can also increase as a result and a third person's “scalper-act can be decreased.

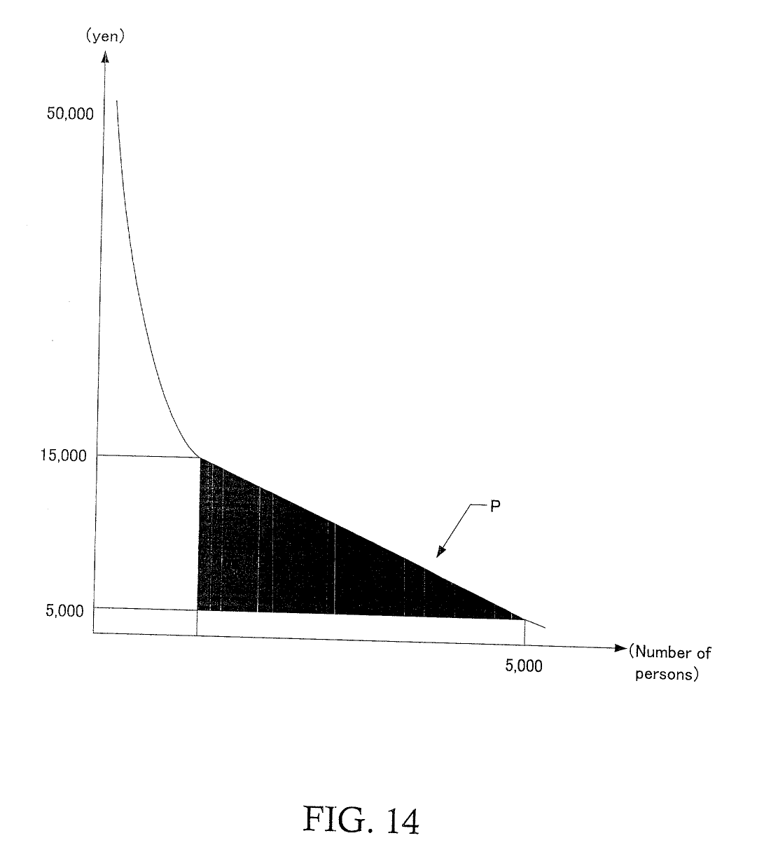

FIG. 14 illustrates a diagram showing the effect of the present invention. A random lottery is usually general as a sales method of the ticket with which demand exceeds supply. This is because it is considered by the world for lots to be the fairest. However, the people who do not desire a random lottery system are in the world very well. Such people belong to certain entertainer's fan club in many cases, for example and wish to surely purchase the ticket. Therefore, a third person's scalper”-act occurs. The auction system can be considered as a countermeasure that prevents it.

In an ordinary auction, there are a goods, the person gave the highest value can buy goods after the person presents the price that the person want to get it and can pay for goods.

Therefore, in the present invention, the structure of the process that extracts 5,000 auction candidates to 1,000 persons, for example to 1,000 tickets is the same at the auction hall.

For example, it is supposed that the ticket of the performance has been knocked down for “15,000 yen” at the auction hall. In this case, it is natural that the person who wants to buy it by payment the high price is represented in 1,000 persons who awarded. In fact, it is expected that the price that you may buy it although it does not appear since it cut with 1,000 persons for convenience and the number of explanation become graph as illustrated in FIG. 14.

The horizontal axis described in FIG. 14 shows the number. In FIG. 4, there are some persons who think may pay 20,000 yen also in 1,000 persons who remained in the auction. There are a few persons (for example, 5-10 persons) who may pay 80,000 or 90,000 yen.

However, since the purpose of the present invention is not profits pursuit of the sponsor, and it is in decreasing a third person's “scalper”-act, the number of participant is decreased within the limits of success-in-an-election probability (the limits with width), using the mechanism of the usual auction, so that the successful bid price of the auction settles in “the price within the limits, black Pin FIG. 14”. Therefore, as compared with the original price of the ticket, it is not knocked down to a handful of people at an extreme price (for example, 80,000 yen). Although a successful bidder is higher than the successful candidate by the lottery system, he can purchase the requested ticket at a comparatively reasonable price (for example, 15,000 yen).

Therefore, a sponsor's profit can also increase as a result and a third person's “scalper”-act can be decreased.

What is claimed is:

1. A selling system of a performance ticket including a server that supplies a performance information to a client terminal through a network comprising:
the server includes a performance information transmitting function which transmits the performance information stored in the performance information DB; an application procedure transmitting function which transmits a purchase information which is stored in a purchase procedure information DB and shown the purport that a selection method of a “lottery system” and on “auction system” about the application of the performance ticket in a display screen of the client terminal; a success-in-an-election probability transmitting function which transmits the success-in-an-election probability information acquired and based on a success-in-an-election probability rule on the basis of a total number of the application and sold ticket number of sheets to the applicant who participates in an auction hall; and a function transmitting notice of success in an election, drawing a lottery means to the applicant who chose the lottery system, on the other hand, awarding with a successful bid means to the participant who chose the auction system, and transmitting the notice of success in the election to the successful bidder and the successful candidate.

2. A selling system of the performance ticket according to claim 1, wherein the success-in-an-election probability rule further includes a formula that is distributed in equal to one of “lottery system” and “auction system” respectively corresponding to the ratio of the total number of the application of the performance after an application registration period end.

3. A selling system of the performance ticket according to claim 1, wherein the server further includes an applicant discernment means that has a function to check when the applicant registered into a lottery system selection person information DB participates in the auction hall further.

4. A selling system of the performance ticket according to claim 1, wherein the server further includes a progress situation transmitting function to transmit the state of auction information.

5. A selling system of a performance ticket including a server that supplies a performance information to a client terminal through a network comprising:
the server includes a performance information transmitting function which transmits a performance information which is stored in a performance information DB and shown the purport that a selection method of a “lottery system” and an “auction system” about the application of the performance ticket in a display screen of the client terminal; an application procedure transmitting function which transmits a purchase information which is stored in a purchase procedure information DB; a success-in-an-election probability transmitting function which transmits the success-in-an-election probability information acquired and based on a success-in-an-election probability rule on the basis of a total number of the application and sold ticket number of sheets to the applicant who participates in an auction hall; and a function transmitting notice of success in an election, drawing a lottery means to the applicant who chose the lottery system, on the other hand, awarding with a successful bid means to the participant who chose the auction system, and transmitting the notice of success in the election to the successful bidder and the successful candidate.

6. A selling system of the performance ticket according to claim 5, wherein the server urges to the accessed client terminal to choose one of “lottery system” and “auction system” on a choice screen about sale of the ticket in the Internet.

7. A selling system of the performance ticket according to claim 5, wherein the server notifies to the screen of the client terminal that another purchase system is offered beforehand to the client surely needed the ticket of the performance although it becomes higher than the regular price after a success-in-an-election probability (or total number of the applications) of the performance becomes clear before the client inputs a matter required into an application data input screen and clicks the last application button and completes the application.
